(19) United States
(12) Patent Application Publication
(10) Pub. No.: US 2005/0115754 A1
(43) Pub. Date: Jun. 2, 2005

(54) Snowmobile with active rider positioning

(75) Inventors: Peter Watson, Thunder Bay (CA); Bruno Girouard, Montreal (CA); Berthold Fecteau, Richmond (CA)

Correspondence Address: BOMBARDIER RECREATIONAL PRODUCTS INC;INTELLECTUAL PROPERTY DEPT, PO BOX 230, NORTON, VT, 05907-0230, US

(73) Assignee: Bombardier Recreational Products Inc., Valcourt (CA)

(21) Appl. No.: 11/029,416

(22) Filed: Jan. 6, 2005

Related U.S. Application Data
(63) Continuation of application No. 10/294,892, filed on Nov. 15, 2002.
Application No. 10/294,892 is a continuation-in-part of application No. 09/877,212, filed on Jun. 11, 2001.
Application No. 10/294,892 is a continuation-in-part of application No. 09/472,134, filed on Dec. 23, 1999.
(60) Provisional application No. 60/237,384, filed on Oct. 4, 2000.
(60) Provisional application No. 60/167,614, filed on Nov. 26, 1999.

(30) Foreign Application Priority Data
Dec. 23, 1998 (CA) 2,256,944

(51) Int. Cl. B62M 27/02

(52) U.S. Cl. 180/190

(57) ABSTRACT

A snowmobile has a frame with a tunnel, a straddle seat, an engine-propelled drive track, and two skis. A steering device operatively connects to the at least one ski to steer the snowmobile. The steering device is positioned such that when the standard rider sits in a standard position on the seat, his knees are disposed in front of his ankles and below his hips. The rider's knees are also disposed sufficiently far below the steering device that the rider's knees do not interfere with steering the snowmobile. This rider positioning enables the rider to easily absorb bumps and to actively position himself on the snowmobile.

### CROSS-REFERENCE

This application is a continuation of U.S. patent application Ser. No. 10/294,892 filed on Nov. 15, 2002. Through the '892 application, this application is a continuation-in-part of U.S. patent application Ser. No. 09/877,212 filed on Jun. 11, 2001. Through the '892 and '212 applications, this application claims the benefit of U.S. Provisional Patent Application No. 60/237,384 filed on Oct. 4, 2000. Also through the '892 application, this application is a continuation-in-part of U.S. patent application Ser. No. 09/472,134, filed on Dec. 23, 1999. Through '892 and '134 applications, this application claims the benefit of U.S. Provisional Patent Application No. 60/167,614 filed on Nov. 26, 1999 and Canadian Patent Application No. 2,256,944 filed on Dec. 23, 1998. All of the aforementioned applications are incorporated herein by reference.

### BACKGROUND OF THE INVENTION

1. Field of the Invention

The present invention concerns the overall design and construction of a snowmobile. More particularly, the present invention concerns the construction and arrangement of various snowmobile components that determine the riding position of a rider thereon.

2. Description of Related Art

Unless otherwise expressly stated, all dimensions for snowmobile riders are based on a standard rider, who is defined by a 50^{th}-percentile United States human male who weighs 78 kilograms (174.8 lb.) and has the dimensions shown in FIGS. 6 and 7. As would be obvious to one of ordinary skill in the art, the dimensions illustrated in FIGS. 6 and 7 are in centimeters with the middle values representing the 50^{th}-percentile U.S. human male. Similarly, all positioning of the riders is based on the positioning of a standard rider on a snowmobile in a standard position. In the standard position, the rider is seated on the seat, is holding the steering device with his hands, and has his feet on the footrest. Accordingly, the rider has the position shown in the Figures (i.e., in the approximate position of a rider a few seconds after starting the vehicle, heading straight ahead on a flat terrain).

Conventional snowmobiles share a common construction: they combine features and elements so that the rider sits in a generally upright position in a location toward the rear of the vehicle. When seated in this fashion, the rider sits a considerable distance behind the center of gravity of the vehicle (i.e., the center of gravity of the combination of the vehicle and the rider), which is located at or in proximity to the axis of the forward-most axle of the drive track.

When a snowmobile encounters a bump as it travels over the ground, the vehicle naturally tends to pivot about its center of gravity. Accordingly, the further the rider is positioned from the center of gravity of the vehicle, the more strongly the rider will feel each bump as he passes over it. This occurs because the vehicle acts as a lever that amplifies the magnitude of the forces transferred from bumps on the ground to the rider. In the case of the conventional snowmobile, because the rider is positioned toward the rear of the vehicle, the rider is acutely aware of this phenomenon.

As is explained in greater detail below, the positioning of the rider on the conventional snowmobile impairs the rider's ability to easily raise and lower himself on the snowmobile. The rider's impaired mobility limits his ability to actively position himself (i.e., position himself so as to absorb bumps, lean into turns, etc.).

Accordingly, while the positioning of the rider on the conventional snowmobile is entirely adequate for enjoying the sport of snowmobiling, a need has arisen for a snowmobile where the rider's position is improved to minimize the effect of the vehicle's movement on the rider as it passes over uneven terrain.

### SUMMARY OF THE INVENTION

The present invention improves upon the conventional design by repositioning the rider on the vehicle and redesigning the layout of the vehicle to minimize the effect of the vehicle's movement on the rider as they pass over uneven terrain.

As would be understood by a person skilled in the art, a snowmobile has a center of gravity without the rider, and may have a different center of gravity with the rider. In the context of the present application it should be understood that the expression “center of gravity of a snowmobile” refers the center of gravity of a snowmobile with the rider, unless the contrary is indicated. Further, it should be understood that in the context of the present invention it is assumed that the vehicle is in running condition and is full of fuel.

One or more embodiments of the present invention provide a snowmobile with a frame that includes a tunnel, an engine disposed on the frame, a drive track disposed below and supported by the tunnel and connected operatively to the engine for propulsion of the snowmobile, and two skis disposed on the frame. A straddle seat is disposed on the frame. The seat is dimensioned to support a standard rider in a standard position, the standard rider having the dimensions and weight of a 50^{th}-percentile human male. A footrest is supported by the frame to support the rider's feet. A steering device is disposed on the frame. The steering device is operatively connected to the two skis for steering the snowmobile. The footrest, straddle seat, and steering device are constructed and arranged such that when the standard rider is in the standard position, the hips are disposed above the knees.

According to a further aspect of these embodiments, when the standard rider is in the standard position, the hips are disposed above the knees by a vertical distance that is preferably between 0 and 20 cm, and is more preferably between 5 and 15 cm.

According to yet a further aspect of these embodiments, the footrest, straddle seat, and steering device are constructed and arranged such that when the standard rider is in the standard position, the hips are disposed behind the ankles by a horizontal distance that is preferably between 5 and 40 cm, is more preferably less than 30 cm, and is even more preferably less than 25 cm.

According to yet a further aspect of these embodiments, the footrest, straddle seat, and steering device are constructed and arranged such that when the standard rider is in the standard position, the rider's hips are positioned behind the steering position by a horizontal distance that is preferably less than 70 cm, is more preferably between 20 and 60 cm, is even more preferably between 35 and 60 cm, is even more preferably between 40 and 60 cm, and is even more preferably about 50 cm.

One or more embodiments of the present invention provide a snowmobile with a frame that includes a tunnel, an engine disposed on the frame, a drive track disposed below and supported by the tunnel and connected operatively to the engine for propulsion of the snowmobile, and two skis disposed on the frame. A straddle seat is disposed on the frame. The seat is dimensioned to support a standard rider in a standard position, the standard rider having the dimensions and weight of a 50-percentile human male. A footrest is supported by the frame to support the rider's feet. A steering device is disposed on the frame forward of the seat. The steering device is operatively connected to the two skis for steering the snowmobile. The footrest, straddle seat, and steering device are constructed and arranged such that when the standard rider is in the standard position, the ankles are disposed behind the knees.

According to a further aspect of embodiments of the present invention, when the standard rider is in the standard position, the ankles are disposed behind the knees by a horizontal distance that is preferably between 5 and 30 cm, and is more preferably between 15 and 25 cm.

According to a further aspect of embodiments of the present invention, the footrest, straddle seat, and steering device are constructed and arranged such that when the standard rider is in the standard position, the knees are disposed below the steering position preferably by at least 10 cm, more preferably by at least 20 cm, and even more preferably by at least 25 cm.

According to a further aspect of embodiments of the present invention, the steering device defines a steering position. The footrest, straddle seat, and steering device are constructed and arranged such that when the standard rider is in the standard position, the ankles are disposed behind the steering position. The ankles are preferably disposed behind the steering position by between 5 and 50 cm, are more preferably disposed behind the steering position by at least 15 cm, and are even more preferably disposed behind the steering position by at least 25 cm.

According to a further aspect of embodiments of the present invention, the footrest, straddle seat, and steering device are constructed and arranged such that when the standard rider is in the standard position, the hips are disposed above the knees.

The hips are preferably disposed behind the ankles by a horizontal distance of less than 30 cm.

According to a further aspect of embodiments of the present invention, the steering device defines a steering position. The footrest, straddle seat, and steering device are constructed and arranged such that when the standard rider is in the standard position, the hips are disposed below the steering position by a vertical distance that is preferably between 0 and 30 cm, and is more preferably between 10 and 25 cm.

One or more embodiments of the present invention provide a snowmobile that includes a frame that includes a tunnel, an engine disposed on the frame, a drive track disposed below and supported by the tunnel and connected operatively to the engine for propulsion of the snowmobile, two skis disposed on the frame, a straddle seat disposed on the frame behind the engine, a footrest supported by the frame, and a steering device disposed on the frame. The steering device operatively connects to the two skis for steering the snowmobile. The steering device defines a steering position that is disposed forwardly from a forward most portion of the footrest.

According to a further aspect of embodiments of the present invention, the steering position is disposed in front of the forward most portion of the footrest by a horizontal distance of at least 5 cm.

One or more embodiments of the present invention provide a snowmobile that includes a frame that includes a tunnel, an engine disposed on the frame, a drive track disposed below and supported by the tunnel and connected operatively to the engine for propulsion of the snowmobile, and two skis disposed on the frame. A straddle seat is disposed on the frame behind the engine and defines a seat position on the snowmobile. A footrest is supported by the frame and defines a footrest position on the snowmobile. A steering device is disposed on the frame and defines a steering position on the snowmobile. The steering device operatively connects to the two skis for steering the snowmobile. The footrest position, steering position, and seat position of the snowmobile are arranged with respect to one another to define an active riding geometry.

According to a further aspect of embodiments of the present invention, the footrest position is disposed 9 cm below the ankle of a standard rider. Similarly, the seat position is disposed 9 cm below the hips of the standard rider. Furthermore, the snowmobile includes a knee position, which is disposed in the same area as the rider's knees at a narrowed portion of the seat. The relative positions of steering position, footrest position, seat position, and knee position can be determined by reference to the relative positions of the steering position and the hips, knees, and ankles of the standard rider.

These aspects as well as additional and/or alternative aspects, objects, and features of the embodiments of the present invention will become apparent from the following description.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 is a side view illustration of a conventional snowmobile, showing the traditional positioning of a rider thereon;

FIG. 2 is a side view of a snowmobile according to the teachings of the present invention, showing the positioning of a rider thereon;

FIG. 3 is a side view illustration of the position of the rider on the snowmobile illustrated in FIG. 2;

FIG. 4 is a top view representation of the snowmobile illustrated in FIG. 2, showing the radius of travel of the steering device through a full range of motion;

FIG. 5 is a perspective view of the frame of the snowmobile of FIG. 2;

FIG. 6 illustrates a front elevational view of a standard rider; and

FIG. 7 illustrates a side elevational view of the standard rider illustrated in FIG. 6.

### DETAILED DESCRIPTION OF PREFERRED EMBODIMENTS

Throughout the description of the various embodiments of the present invention, reference will be made to various elements, the construction of which is readily known to those skilled in the art. Accordingly, an exhaustive description of each and every component is not provided, only a description of those elements required for an understanding of the present invention.

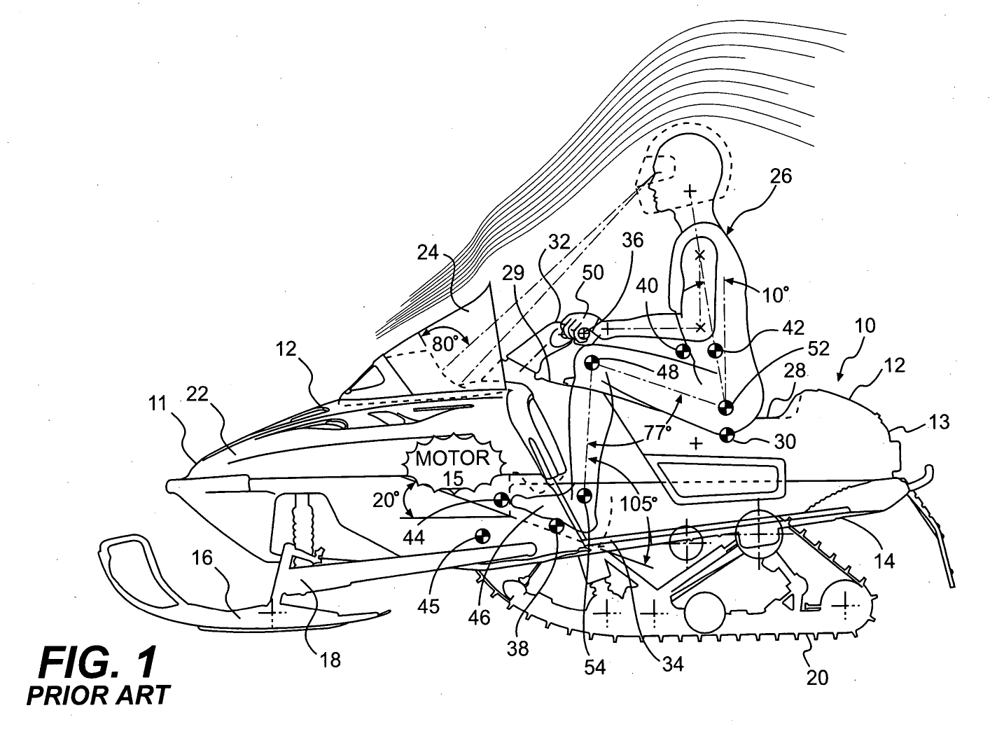

FIG. 1 illustrates a conventional snowmobile 10 (that sold by Bombardier Inc. of Montreal, Canada, under the trademark SKI-DOO, model MXZ, model year 1999), which has a forward end 11 and a rearward end 13, which are defined consistently with the travel direction of the vehicle 10. Conventional snowmobile 10 includes a body 12 (i.e., the exterior upper portions) and a frame 14. An engine/motor 15 is carried by frame 14 at its forward end. In addition, two skis 16 are attached to the forward end of frame 14 through a suspension system 18. A drive track 20 is disposed under frame 14 and is connected operatively to the engine/motor 15 for propulsion of the vehicle 10.

At the front of frame 14, snowmobile 10 includes fairings 22 that enclose the engine 15 to protect it and to provide an external shell that can be decorated so that the snowmobile 10 is aesthetically pleasing. Typically the fairings 22 comprise a hood and a bottom pad (neither of which have been individually identified). A windshield 24 may be connected to fairings 22 near the forward end 11 of snowmobile 10. Windshield 24 acts as a windscreen to lessen the force of the air on rider 26 when snowmobile 10 is moving.

A seat 28 extends from rearward end 13 of snowmobile 10 to the fuel tank 29. A steering device 32, such as a handlebar, is positioned forward of rider 26 and behind the engine 15. Two footrests 34 are positioned on either side of seat 28 to accommodate the rider's feet 46.

When seated, the standard rider 26 will be positioned so that his hands grasp steering device 32 at steering position 36. Moreover, rider 26 will be seated so that the center of his torso 42 is above seat position 30. When seated in this manner, the rider's feet 46 naturally will be placed at footrest position 38. Positioned in this manner, the rider's center of gravity 40 will be located just forward of the rider's stomach, offset from the center of the rider's torso 42. The rider's center of gravity 40 is offset forwardly from the center of the rider's torso 42 because the rider's arm and legs are disposed forward of the rider's torso 42 when rider 26 is in the driving position.

For conventional snowmobile 10, the rider's center of gravity 40 is behind the center of gravity of the snowmobile 44 (i.e., the center of gravity of the snowmobile with the rider). The center of gravity of the snowmobile 44 is located on or near the forward-most axle 45 of drive track 20. While the forward-most axle of drive track 20 is not shown, those skilled in the art will readily appreciate that it is located at or near the position labeled as the center of gravity of the vehicle 44. In addition, footrests 34 are inclined upwardly from the horizontal so that the rider's feet 46 are in a comfortable position when rider 26 is seated on snowmobile 10. Consequently, the bottom of the rider's foot 46 (or the sole of his footwear) forms about a 20 degree angle with a horizontal plane.

For conventional snowmobile 10, the positioning of these various components and elements creates a situation where the standard rider 26 is seated in a relatively upright position toward the rear of the vehicle 10. As shown in FIG. 1, with the rider's feet 46 positioned on footrests 34, the rider's knees 48, which are defined by the knee joints, are positioned close to the steering position 36 where the rider's hands 50 are located. The rider's hip 52, which is defined by the hip joint, is disposed below the rider's knee 48. The rider's ankle 54, which is defined by the rider's ankle joint, is disposed forwardly from the rider's knee 48 and the steering position 36. These elements, coupled with the placement of steering position 36 behind foot position 38, create a situation where rider 26 sits inclined slightly forward, as indicated in FIG. 1.

The positioning of rider 26 shown in FIG. 1 is considered standard, i.e., the standard riding position. While riders may move out of the standard riding position under various riding conditions (e.g., when traversing obstacles, making tight turns, etc.), the standard riding position is used during normal relaxed riding (e.g., long distance riding, touring, etc.).

Before the present invention, there was no motivation to adjust the position of rider 26 because the standard position does not hinder operation of the vehicle nor does it create an unsafe riding condition for rider 26. Moreover, the conventional positioning of rider 26 on snowmobile 10 does not prevent rider 26 from enjoying the sport of snowmobiling.

Despite this, the inventors of the present invention realized that it is possible to improve upon the construction of a snowmobile to alter the positioning of the rider to improve considerably the handling and ride of the vehicle.

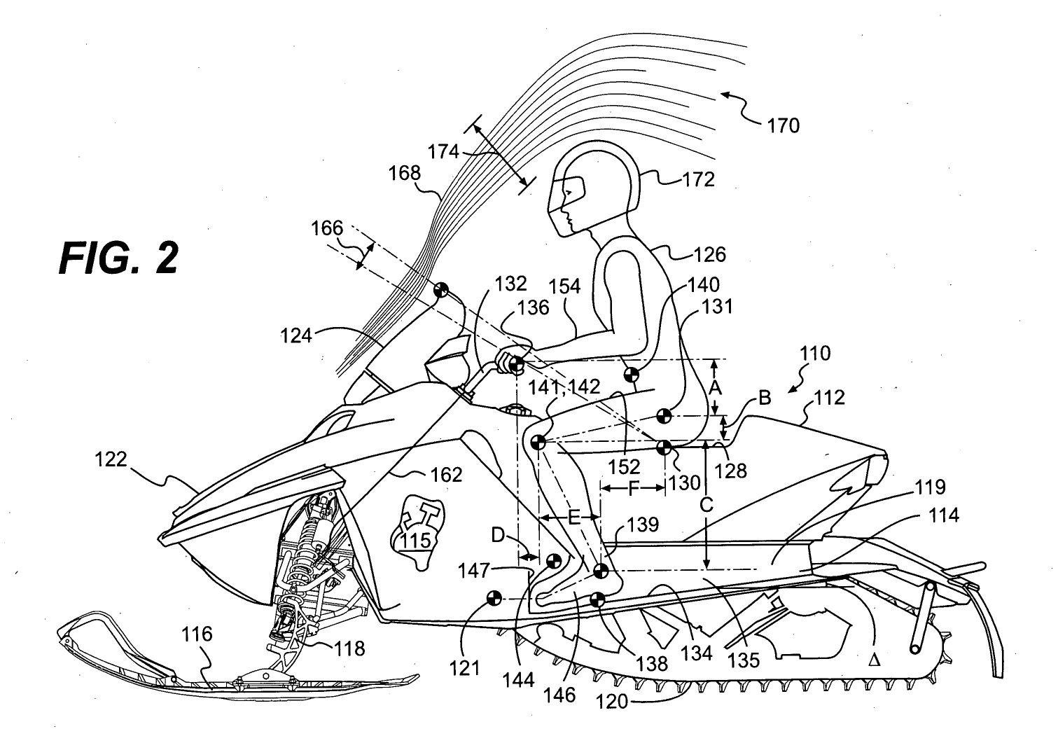

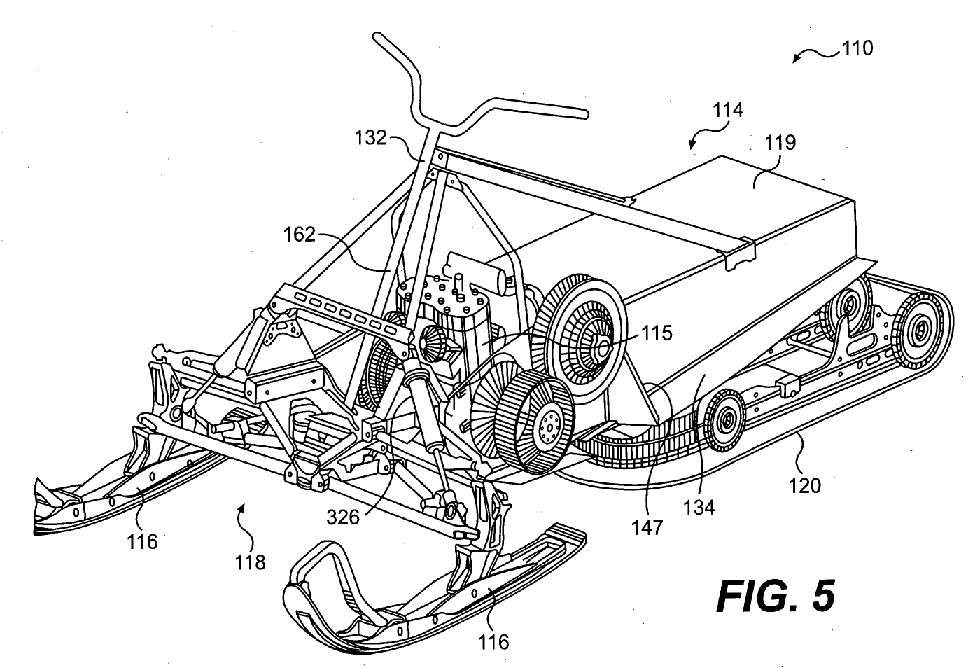

FIGS. 2 and 5 illustrate snowmobile 110, which is made according to the teachings of the present invention.

Like snowmobile 10, snowmobile 110 has a body 112 and a frame 114. Two skis 116 are positioned at the front of frame 114 so that snowmobile 110 may be steered over the snow. Skis 116 are connected to frame 114 through a suspension system 118 attached to frame 114 at its forward end. An engine 115 is also disposed at the forward end of snowmobile 110 and is covered by fairings 122 that protect the engine 115 and provide snowmobile 110 with an aesthetically pleasing appearance. A windshield 124 may extend upwardly from fairings 122 to act as a windscreen for rider 126.

The frame 114 includes a tunnel 119. The tunnel 119 may comprise one or more pieces of bent sheet metal. A drive track 120, which is operatively connected to the engine 115, is supported below the tunnel 119 via a suspension system. The tunnel 119 is constructed such that an upper portion of the drive track 120 fits into a longitudinal channel formed in the underside of the tunnel 119.

Drive track 120 is a continuous belt that runs around a number of axles including a forward-most axle 121 that is obscured by fairings 122 in FIG. 2. Forward-most axle 121 of snowmobile 110 is at or near the center of gravity 144 of snowmobile 110 with the rider 126, as would be understood by those skilled in the art.

When rider 126 is on snowmobile 110, the rider will be positioned on seat 128 so that he occupies seat position 130. Seat position 130 is the point at which the weight of the rider 126 is exerted on the seat 128, and is generally disposed 9 cm below the hips 131 of the rider 126. It will also be understood that seat 128 will be covered with an amount of foam or similar padding-type material, and that the amount of that foam will vary from seat to seat. When the rider 126 sits upon the seat 128, his weight will cause the foam to compress and he will sink into the seat 128. Preferably, the seating position 130 and hip 131 location is determined after this compression has occurred.

Steering device 132 is positioned at the forward end of snowmobile 110 and above the engine 115. As is the case with the seating position 130, the steering position 136 may vary depending on the size and shape of the hands of the rider 126. In cases of difficulty, the steering position 136 may be determined by placing the hands of the standard rider described above on the steering device 132 in the standard position. The steering position 136 will be the intersection of the center of the palm of the hands of the rider 126 and the steering device 132.

It should be noted that steering device 132 is shown as a handlebar but should not be limited to just this particular construction. It would be understood by those skilled in the art that any suitable steering device may be used for snowmobile 110. For example, steering device 132 could be a steering wheel or a yoke of the type used in aircraft. Moreover, the positioning of steering device 132 above the engine 115 also should not be considered to be limited to the position illustrated in FIG. 2. As would be understood by those skilled in the art, depending on the particular arrangement of elements for the snowmobile, it is possible that steering device 132 could be positioned higher or lower than shown in FIG. 2 without departing from the scope and spirit of the present invention.

Footrests 134 are disposed on both sides of the seat 128 and may be formed integrally with or be supported by the tunnel 119 of the frame 114. In the embodiment illustrated in FIG. 5, the footrests 134 are integrally formed with the tunnel 119 such that the tunnel 119 provides the structural support for the rider's feet 146. The rider's feet 146 rest on footrests 134 in footrest position 138 just behind the center of gravity 144 of the vehicle 110. The footrest position 138 is in the location of the arch of the foot of the rider 126 when his feet are placed in the standard position on the vehicle. Under normal operating conditions, the rider's feet 146 will rest on a forward portion of the sideboards/footrests 134. This foot positioning places the rider's ankles 139, which are defined by the ankle joint, 9 cm above the footrest position 138.

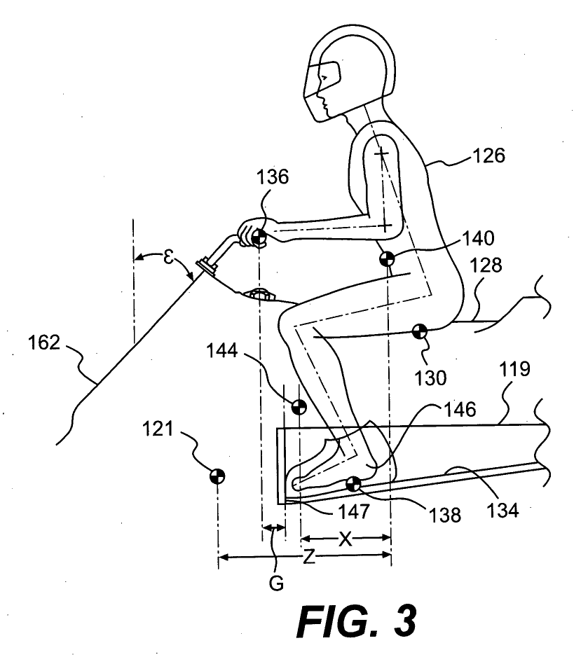

As illustrated in FIG. 3, the forward most portion 147 of the footrest 134, which is defined by the forward most possible position of the front of the rider's feet 146, is preferably disposed behind the steering position 136 by a distance G. Distance G is preferably greater than 0, is more preferably between 5 and 50 cm, is even more preferably between 5 and 20 cm, and is even more preferably about 10 cm.

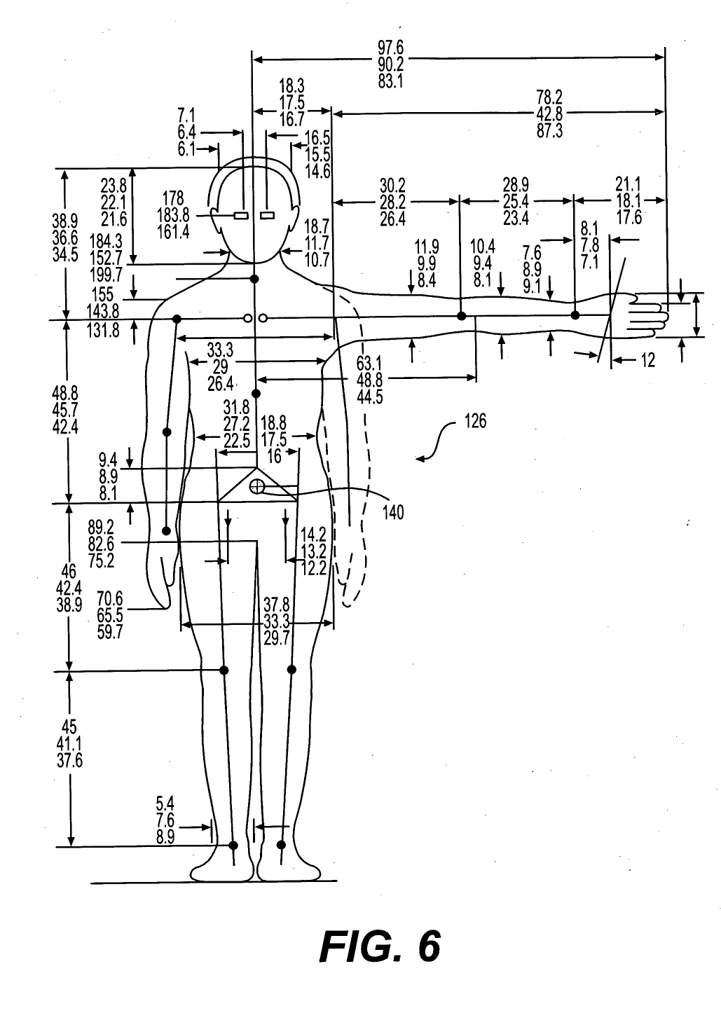

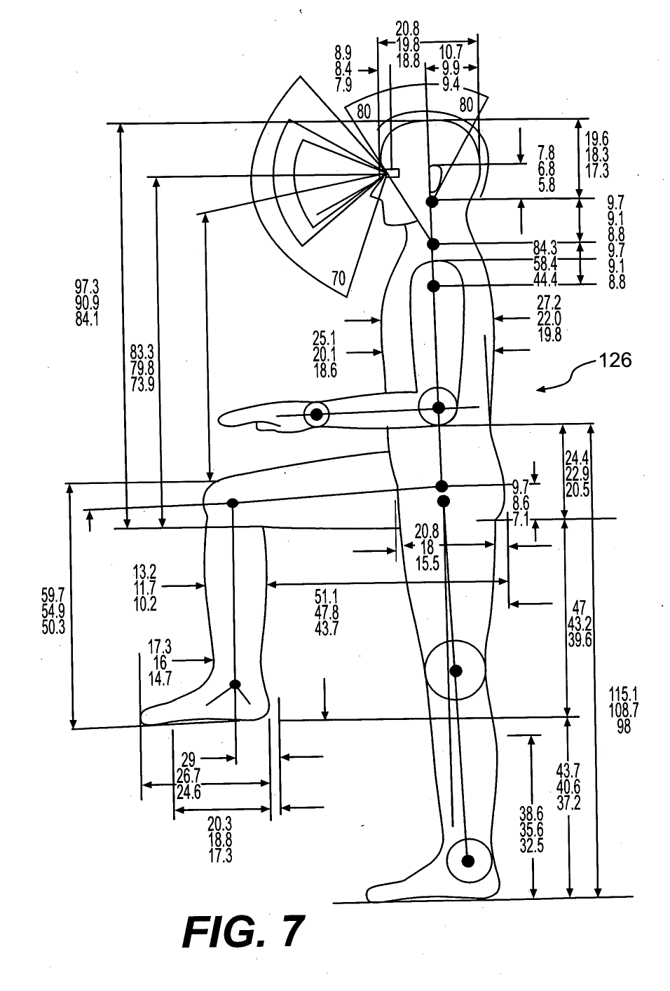

The rider's ankle 139 and hip 131 positions determine the position of the rider's knees 141, which are defined by the knee joints. As illustrated in FIGS. 6 and 7, for the standard rider 126, the distance between the rider's ankles 139 and knees 141 is 41.1 cm. Similarly, the distance between the rider's knees 141 and hips 131 is 42.4 cm.

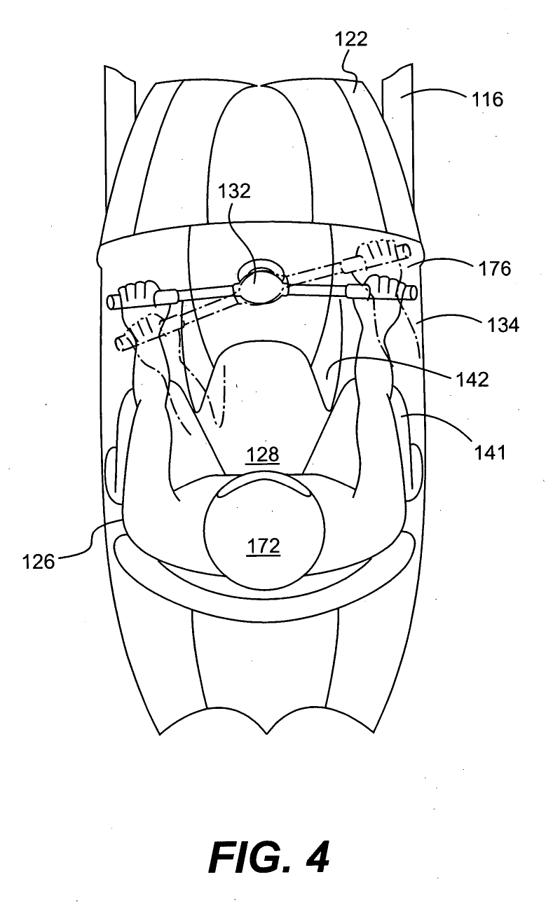

As illustrated in FIG. 4, the rider's knees 141 fit into a knee position 142 on the snowmobile 110. The knee position 142 is defined by a narrowed forward portion of the seat 128 that is designed to accommodate the rider's knees 141. As illustrated in FIG. 2, the knee position 142 is preferably disposed at the same vertical and longitudinal position on the snowmobile 110 as the rider's knees 141. The open space formed at the knee position 142 enables the rider 126 to actively position himself and more easily lean into turns because the knee position 142 allows the rider's outside knee 141 to move farther into the turn.

When the standard rider 126 is in the standard position on the snowmobile 110, the seat 128, footrest 134, and steering device 132 are positioned such that the rider's hips 131 will be disposed below the steering position 136 by a vertical distance A. Distance A is preferably between 0 and 30 cm., is more preferably between 10 and 25 cm, and is even more preferably about 18 cm. Similarly, the rider's hips 131 will be disposed above the rider's knees 141 by a vertical distance B. Distance B is preferably between 0 and 20 cm., is more preferably between 5 and 15 cm, and is even more preferably about 10 cm. The rider's knees 141 will be disposed above the rider's ankles 139 by a vertical distance C. Distance C is preferably between 10 and 40 cm, is more preferably between about 20 and 40 cm, and is even more preferably about 36 cm.

When the standard rider 126 is in the standard position on the snowmobile 110, the seat 128, footrest 134, and steering device 132 are positioned such that the rider's knees 141 will be disposed at least slightly rearwardly from the steering position 136. As illustrated, the rider's knees 141 will be disposed behind the steering position 136 by a horizontal distance D, which is preferably between 0 and 30 cm, is more preferably between about 0 and 20 cm, and is even more preferably about 10 cm. Alternatively, the rider's knees 141 may be disposed in front of the steering position 136 such that the distance D is negative (e.g., −5 cm, −10 cm, etc.). The rider's knees 141 will be disposed forwardly from the rider's ankles 139 by a horizontal distance E. Distance E is preferably between 0 and 35 cm, is more preferably between 5 and 30 cm, is even more preferably between 15 and 25 cm, and is even more preferably about 18 cm. The rider's hips 131 will be disposed rearwardly from the rider's ankles 139 by a horizontal distance F. Distance F is preferably between 5 and 40 cm, is more preferably between 10 and 30 cm, and is even more preferably about 22 cm.

The rider's hips 131 are positioned behind the steering position 136 by a horizontal distance that equals distance D plus distance E plus distance F. Distance D+E+F is preferably less than 70 cm. In an alternative embodiment, distance D+E+F is preferably between 20 and 80 cm, is more preferably between 30 and 70 cm, is even more preferably between 35 and 60 cm, is even more preferably between 40 and 60 cm, and is even more preferably about 50 cm. The resulting hip 131 position preferably places the rider's center of gravity 140 closer to the center of gravity 144 of the snowmobile 110, and thereby centralizes the combined mass of the ATV 110 and rider 126. Centralizing the combined mass makes it easier to turn the snowmobile 110 because it improves the snowmobile's handling and responsiveness. This principle is highlighted by the fact that it is easier to rotate a 10 kilogram bowling ball than it is to rotate a 10 kilogram ladder.

This rider positioning also preferably positions the rider 126 closer to the longitudinal center of the snowmobile 110, which places the rider 126 closer to the snowmobile's natural pivot point. Because the rider 126 and the snowmobile 110 will tend to pivot at similar points, the rider experiences a more comfortable ride as the snowmobile 110 traverses uneven terrain or obstacles. This principle is highlighted by the fact that a person sitting in the back seat of a bus experiences more jostling forces than a person sitting toward the middle of the bus.

The knee position 142 is located at the same position as the knees 141. The seat position 130 is disposed 9 cm below but generally at the same longitudinal position as the hips 131. The ankles 139 are disposed 9 cm above but generally at the same longitudinal position as the foot position 138. Accordingly, the relative positions of the steering position 136, seat position 130, knee position 142, and foot position 138 of the snowmobile 110 can be determined with reference to the distances A-F.

Hereinafter, several of the advantages of the snowmobile 110 will be described with reference to FIGS. 1 and 2.

When rider 26 is sitting on conventional snowmobile 10, if he sees a large bump ahead, it is natural for rider 26 to try to raise himself off of seat 28 to minimize the impact of the bump as he passes over it. However, because of his positioning on conventional snowmobile 10, in order for rider 26 to stand up, he must pull on steering device 32 using his upper body. The positioning of the rider's feet 46 forward of the rider's center of gravity 40 and at an incline on footrests 34 makes it difficult for rider 26 to stand on snowmobile 10 using only the strength of his legs. Moreover, even after rider 26 lifts himself from seat 28, his center of gravity 40 remains sufficiently rearward of the center of gravity of the vehicle 44 that he will perceive the large bump.

In snowmobile 110 of the present invention, however, a wholly different result is achieved. First, steering position 136 is moved forward relative to the conventional snowmobile 10. This position pulls rider 126 forward of the conventional position. By moving seat position 130 closer to the center of gravity of the vehicle 144 than the conventional example, redesigning footrests 134 so that they are kept at a decline, and positioning the rider's feet 146 horizontally closer to the rider's center of gravity 140, rider 126 is positioned so that, if a large bump is seen in the path ahead, rider 126 can easily raise himself from the seat using primarily the strength of only his legs 152. The seat 128, steering device 132, and footrests 134 are positioned such that the rider's hips 131, knees 141, and ankles 139 create a positioning that enables the rider 126 to easily raise and lower himself to traverse obstacles. The rider's ability to actively position himself improves the rider's control over the snowmobile 110. Since rider 126 is disposed closer to the center of gravity of the vehicle 144, when snowmobile 110 passes over a large bump, the effect of the bump is not transferred to rider 126 with the same magnitude as the force transferred to rider 26 on conventional snowmobile 10.

In addition, because rider 126 can raise himself from seat 128 using his legs 152 and not his arms 154, rider 126 can maintain greater control over snowmobile 110 as he passes over the obstacle than rider 26 on conventional snowmobile 10. If rider 26 (of conventional snowmobile 10) tries to pull himself from seat 28 as he passes over a large bump or obstacle, he sacrifices some of this strength pulling himself up from seat 28 and, therefore, may be less able to steer and control the vehicle 10 as he passes over the obstacle.

The ability of the rider 126 to lift himself using his legs 152 also relieves stress on the rider's back. When the conventional rider 26 uses his arms to raise himself on a conventional snowmobile 10, the rider's lifting force is transferred through his back, which stresses his back and fatigues the rider 26. Similarly, the rider 26 uses his back to absorb movement during snowmobile operation. Conversely, because the rider 126 of the snowmobile 110 can lift himself using primarily his legs 152, fewer forces are transferred through the rider's back and the rider 126 experiences a more comfortable ride.

To facilitate the rider's ability to raise himself off of seat 128 using his legs 152, footrests 134 are not inclined as with snowmobile 10. Instead, footrests 134 are part of the forward portion of the sideboards 135 that laterally extend from the tunnel 119 below the seat 128 on either side thereof. As a result, footrests 134 are at angle Δ with respect to the horizontal. Preferably, angle Δ is between about +10 and −20°. More preferably, angle Δ lies between about +10 and −10°. Even more preferably, angle Δ lies between about 0 and −5°. Most preferably, angle Δ is about −5°.

As mentioned, one aspect of the present invention that improves upon the conventional snowmobile 10 is the fact that the rider's center of gravity 140 is closer to the center of gravity of the vehicle 144 than in the conventional example. This positioning helps to minimize the effect of bumps and terrain on rider 126. Referring to FIG. 3, it is preferred that a distance x, measured as the distance between a vertical line passing through the center of gravity of the vehicle 144 and a vertical line passing through the center of gravity of the rider 140, be between about 0 and 50 cm. It is more preferred that distance x be between about 10 and 40 cm. In still a more preferred example, distance x is between about 22 and 32 cm. In the most preferred example, distance x is between about 25 and 30 cm. Similarly, a distance z between a vertical line passing through the forward-most drive track axle 121 (usually, but not exclusively the drive axle) and a vertical line passing through the center of gravity of the rider 140 is preferably between about 15 and 65 cm. More preferably, distance z is between about 25 and 55 cm. Still more preferably, distance z is between about 35 and 55 cm. Still more preferably, distance z is between about 37 and 47 cm. Most preferably, distance z is about 40 cm or about 45 cm.

As discussed above, the steering position 136 of the snowmobile 110 is pushed forward relative to the conventional snowmobile 10. To create this steering position 136, the inventors altered the positioning of the axis of the steering shaft 162 of the steering device 132 so that it is more steeply sloped than the steering shaft in prior art snowmobiles having a steering shaft over the engine. With a steeper slope to the axis of the steering shaft 162, the turning force applied by rider 126 is more directly applied to steer the vehicle 110. According to the present invention, and as illustrated in FIGS. 2 and 3, the axis of the steering shaft 162 forms an angle ε with vertical that is less than 45°. More preferably, angle ε lies between about 25 and 40°. Even more preferably, angle ε lies between about 30 and 35°. Most preferably, angle ε is about 33°.

Returning to FIG. 2, positioning rider 126 on snowmobile 110 in the manner described has still further advantages. Windshield 124 has a top 166. When snowmobile 110 is moving, top 166 of windshield 124 defines a point from which the air travels along a travel path 168. The air along air travel path 168 will have laminar flow characteristics until it reaches a turbulent flow region 170. When rider 126 is positioned on snowmobile 110 as described above, the rider's head 172 falls within the laminar flow region 174. As a result, rider 126 enjoys a more comfortable ride because the air has a less adverse effect on his head 172 in terms of temperature, noise, etc. This advantageous air flow is achieved, in part, because of the physical relationship between the seat position 130, steering position 136, and top 166. Specifically, as illustrated in FIG. 2, a line between the steering position 136 and the seat position 130 forms an angle μ with a line between the seat position 130 and the top 166 of the windshield that lies between about 0 and 20°. More preferably, angle μ is between about 10 and 20°. Most preferably, angle μ is about 18°. Those skilled in the art will readily recognize that the resulting positioning of the rider's head 172 on snowmobile 110 is very different than that for conventional snowmobile 10, where the head of rider 26 falls into the turbulent flow region. Accordingly, rider 26 experiences a poorer quality ride than rider 126.

The positioning of rider 126 on snowmobile 110 in the manner taught by the present invention offers still further advantages. As illustrated, the view that rider 126 has of the ground in front of him is much improved over the view of the ground in front of rider 26 on conventional snowmobile 26. This is true because rider 126 has less of the snowmobile fairings 122 and windshield 124 in front of him than rider 26 does. As a result, rider 126 is better able to react to obstacles in his immediate path than rider 26.

The design of snowmobile 110 offers still further advantages. For example, as illustrated in FIG. 1, the rider's knees 48 are positioned very close to steering position 36. As a result, when rider 26 steers snowmobile 10, it is not uncommon for rider 26 to hits his knees 48 with steering device 32. This presents a minor design difficulty that the present invention solves. As illustrated in FIG. 2, the knees 141 of the rider 126 on the snowmobile 110 are disposed below the steering position 136 by a vertical distance that equals distance A plus distance B, which is preferably greater than 10 cm, is more preferably greater than 15 cm, is even more preferably greater than 20 cm, and is even more preferably about 28 cm.

As shown in FIG. 4, when rider 126 turns steering device 132 to its maximum positions, the handlebars sweep out a handlebar space 176. Because steering device 132 is positioned forward of the center of gravity of the vehicle 144, handlebar space 176 cannot intersect with the space occupied by rider 126. In other words, rider 126 will not normally hit his knees 141 with steering device 132 while riding snowmobile 110.

The present invention offers still further advantages over the design of conventional snowmobile 10. Since rider 126 is positioned closer to the center of gravity of the vehicle 144, the ride for a second rider on the same vehicle is also improved because the second occupant is also disposed closer to the center of gravity of the vehicle. Rider 26 (who is shown astride conventional snowmobile 10) is essentially in the second passenger seat for snowmobile 110. Since rider 126 has been moved forward, the second rider is subject to the kind of forces that he would be subjected to if he were driving a conventional snowmobile 10. In other words, the second rider is no worse off than he would be if he were rider/driver 26 on conventional snowmobile 10. Indeed the second rider's situation is quite improved, and may approach that of a rider 26 on a conventional snowmobile 10.

In addition, since second rider experiences a similar ride experience to what rider 26 experiences on conventional snowmobile, it is possible that a third rider could be added to snowmobile 110 behind the second rider. The third rider, then, would experience the forces similar to those that a second rider would normally experience on conventional snowmobile 10.

While the invention has been described with reference to several preferred embodiments, it will be understood by those skilled in the art that various changes may be made and equivalents may be substituted for elements thereof without departing from the spirit and scope of the present invention. In addition, many modifications may be made to adapt a particular situation, component, or material to the teachings of the present invention without departing from its teachings.

1. A snowmobile, comprising:
a frame having a tunnel, the tunnel including a piece of bent sheet metal forming at least in part a longitudinal channel in an underside thereof;
an engine disposed on the frame;
a drive track disposed at least in part in the longitudinal channel of the tunnel and connected operatively to the engine for propulsion of the snowmobile;
two skis disposed on the frame;
a straddle seat disposed on the tunnel above the drive track and rearward of the engine, the seat being dimensioned to support a standard rider having the dimensions and weight of a 50-percentile human male, the seat having a seating position;
a pair of footrests supported by the frame to support the rider's feet, the footrests having a footrest position; and
a handlebar disposed on the frame, the handlebar being operatively connected to the two skis for steering the snowmobile, the handlebar having handgrips at ends thereof, the handgrips having a steering position,
the snowmobile constructed and arranged such that when the standard rider is in a standard position defined as the standard rider straddling and being seated on the seat on the seating position with its feet disposed on the footrests on the footrest position and its hands disposed on the handgrips on the steering position with the snowmobile being steered straight on flat terrain and being in running condition, the hips of the standard rider are disposed above its knees by a vertical distance of between 5 and 15 cm.

2. The snowmobile of claim 1, wherein the snowmobile is constructed and arranged such that when the standard rider is in the standard position, its hips are disposed behind the steering position by a horizontal distance of between 20 and 60 cm.

3. The snowmobile of claim 1, wherein the snowmobile is constructed and arranged such that when the standard rider is in the standard position, its hips are disposed behind its ankles by a horizontal distance of between 5 and 40 cm.

4. The snowmobile of claim 1, wherein the snowmobile is constructed and arranged such that when the standard rider is in the standard position, its ankles are disposed behind its knees by a horizontal distance of between 5 and 30 cm.

5. The snowmobile of claim 1, wherein the snowmobile is constructed and arranged such that when the standard rider is in the standard position, its ankles are disposed behind the steering position by a horizontal distance of between 5 and 50 cm.

6. The snowmobile of claim 1, wherein the snowmobile is constructed and arranged such that when the standard rider is in the standard position, its hips are disposed below the steering position by a vertical distance of between 10 and 25 cm.

7. The snowmobile of claim 1, wherein the snowmobile is constructed and arranged such that when the standard rider is in the standard position, its knees are disposed below the steering position by a vertical distance of at least 10 cm.

8. A snowmobile, comprising:
a frame having a tunnel, the tunnel including a piece of bent sheet metal forming at least in part a longitudinal channel in an underside thereof;
an engine disposed on the frame;
a drive track disposed at least in part in the longitudinal channel of the tunnel and connected operatively to the engine for propulsion of the snowmobile;
two skis disposed on the frame;
a straddle seat disposed on the tunnel above the drive track and rearward of the engine, the seat being dimensioned to support a standard rider having the dimensions and weight of a 50-percentile human male, the seat having a seating position;
a pair of footrests supported by the frame to support the rider's feet, the footrests having a footrest position; and
a handlebar disposed on the frame, the handlebar being operatively connected to the two skis for steering the snowmobile, the handlebar having handgrips at ends thereof, the handgrips having a steering position,
the snowmobile constructed and arranged such that when the standard rider is in a standard position defined as the standard rider straddling and being seated on the seat on the seating position with its feet disposed on the footrests on the footrest position and its hands disposed on the handgrips on the steering position with the snowmobile being steered straight on flat terrain and being in running condition, the ankles of the standard rider are disposed behind its knees by a horizontal distance of between 5 and 30 cm.

9. The snowmobile of claim 8, wherein the snowmobile is constructed and arranged such that when the standard rider is in the standard position, its hips are disposed behind the steering position by a horizontal distance of between 20 and 60 cm.

10. The snowmobile of claim 8, wherein the snowmobile is constructed and arranged such that when the standard rider is in the standard position, its hips are disposed behind its ankles by a horizontal distance of between 5 and 40 cm.

11. The snowmobile of claim 8, wherein the snowmobile is constructed and arranged such that when the standard rider is in the standard position, its ankles are disposed behind the steering position by a horizontal distance of between 5 and 50 cm.

12. The snowmobile of claim 8, wherein the snowmobile is constructed and arranged such that when the standard rider is in the standard position, its hips are disposed below the steering position by a vertical distance of between 10 and 25 cm.

13. The snowmobile of claim 8, wherein the snowmobile is constructed and arranged such that when the standard rider is in the standard position, its knees are disposed below the steering position by a vertical distance of at least 10 cm.

14. A snowmobile, comprising:
a frame having a tunnel, the tunnel including a piece of bent sheet metal forming at least in part a longitudinal channel in an underside thereof;
an engine disposed on the frame;
a drive track disposed at least in part in the longitudinal channel of the tunnel and connected operatively to the engine for propulsion of the snowmobile;
two skis disposed on the frame;
a straddle seat disposed on the tunnel above the drive track and rearward of the engine, the seat being dimensioned to support a standard rider having the dimensions and weight of a 50-percentile human male, the seat having a seating position;
a pair of footrests supported by the frame to support the rider's feet, the footrests having a footrest position; and
a handlebar disposed on the frame, the handlebar being operatively connected to the two skis for steering the snowmobile, the handlebar having handgrips at ends thereof, the handgrips having a steering position,
the snowmobile constructed and arranged such that when the standard rider is in a standard position defined as the standard rider straddling and being seated on the seat on the seating position with its feet disposed on the footrests on the footrest position and its hands disposed on the handlebar on the steering position with the snowmobile being steered straight on flat terrain and being in running condition, the hips of the standard rider are disposed behind its ankles by a horizontal distance of between 5 and 40 cm.

15. The snowmobile of claim 14, wherein the snowmobile is constructed and arranged such that when the standard rider is in the standard position, its hips are disposed behind the steering position by a horizontal distance of between 20 and 60 cm.

16. The snowmobile of claim 14, wherein the snowmobile is constructed and arranged such that when the standard rider is in the standard position, its ankles are disposed behind the steering position by a horizontal distance of between 5 and 50 cm.

17. The snowmobile of claim 14, wherein the snowmobile is constructed and arranged such that when the standard rider is in the standard position, its hips are disposed below the steering position by a vertical distance of between 10 and 25 cm.

18. The snowmobile of claim 14, wherein the snowmobile is constructed and arranged such that when the standard rider is in the standard position, its knees are disposed below the steering position by a vertical distance of at least 10 cm.
